(19) United States
(12) Patent Application Publication
(10) Pub. No.: US 2008/0113863 A1
(43) Pub. Date: May 15, 2008

(54) Rewritable thermal label of non-contact type

(75) Inventors: Chisato Iino, Koshigaya-shi (JP); Takehiko Nishikawa, Saitama-shi (JP); Tetsuyuki Utagawa, Kawaguchi-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: LINTEC CORPORATION, Tokyo (JP)

(21) Appl. No.: 11/977,544

(22) Filed: Oct. 25, 2007

(30) Foreign Application Priority Data
Nov. 15, 2006 (JP) 2006-309008

(51) Int. Cl. B41M 5/26

(52) U.S. Cl. 503/226

(57) ABSTRACT

A rewritable thermal label of the non-contact type which comprises a transparent substrate, a rewritable thermal layer disposed on the transparent substrate and an adhesive layer disposed on the rewritable thermal layer and enables to rewrite visible information with laser light in the non-contact manner. The label exhibits improved durability in rewriting (resistance to destruction with heat) and improved property for printing while the property for repeated recording and erasure with laser light is maintained and enables to write and/or erase visible information with laser light in the non-contact manner automatically without human labor.

### TECHNICAL FIELD

The present invention relates to a rewritable thermal label of the non-contact type. More particularly, the present invention relates to a rewritable thermal label of the non-contact type which exhibits improved durability in rewriting (resistance to destruction with heat) and improved property for printing while the property for repeated recording and erasing with laser light is maintained and enables to write and/or erase visible information with laser light in the non-contact manner automatically without human labor.

### BACKGROUND ART

In labels used for physical distribution management, a heat sensitive recording material of the contact type is mainly used as the surface substrate. Information such as the address, the name of the sender, the name of the article, the number and the weight of the article, the date of production, the best-before date, the specific identification number and the lot number or a bar code expressing the information is printed using a thermal printer of the contact type, and the obtained label is attached to the adherend. When the object assigned to the label is achieved, the label is manually removed so that the adherend such as a container and a card board box can be reused again, and great amounts of time and labor are required for the removal. Another label is attached to the adherend from which the previous label has been removed, and the adherend is used again.

As described above, it is the actual situation at present that a label is removed and another label is attached every time the adherent is reused. Therefore, a rewritable thermal label which can be used repeatedly for recording and erasing information while the label remains attached to the adherend without being removed from the adherend in each reuse of the adherend is attracting attention. For example, a reversible heat sensitive recording material of the non-contact type having a means for recording and erasing visible information which is obtained by forming a heat sensitive color developing layer containing a dye precursor and a reversible color developing agent on a support is developed.

Heretofore, a white substrate is coated with a heat sensitive color developing layer and a light absorption and heat conversion layer so that optical readability is surely obtained. This construction has drawbacks in that the surface of the recording medium is destroyed with heat of laser light which is repeatedly applied when recording and erasing are repeated a plurality of times since laser light is applied directly to the rewritable layer, and that, when printing of fixed information and various colored marks in accordance with some printing method is desired in addition to the recording of changeable information utilizing the heat sensitive color development, the printing is not possible since the printing ink is not tightly attached to the heat sensitive recording layer (poor adhesion).

[Patent Reference 1] Japanese Patent Application Laid-Open No. 2003-118238

[Patent Reference 2] Japanese Patent Application Laid-Open No. 2003-320695

[Patent Reference 3] Japanese Patent Application Laid-Open No. 2004-90026

[Patent Reference 4] Japanese Patent Application Laid-Open No. 2005-250578

[Patent Reference 5] Japanese Patent Application Laid-Open No. 2005-111869

### DISCLOSURE OF THE INVENTION

Under the above circumstances, the present invention has an object of providing a rewritable thermal label of the non-contact type which exhibits improved durability in rewriting (resistance to destruction with heat) and improved property for printing while the property for repeated recording and erasing with laser light is maintained and enables to write and/or erase visible information with laser light in the non-contact manner automatically without human labor.

As the result of intensive studies by the present inventors to achieve the above object, it was found that the durability in rewriting could be improved by using a label for rewriting visible information in the non-contact manner having at least a reversible heat sensitive color developing layer disposed on one face of a transparent substrate and an adhesive layer disposed on the outer face and by irradiating the reversible heat sensitive color developing layer with laser light through the transparent substrate, that the property for printing could be improved by disposing a coating layer for printing on one or both faces of the transparent substrate, and that an optical readability similar to that of a conventional white substrate could be exhibited when the adhesive layer is made white. The present invention has been completed based on the knowledge.

The present invention provides:
[1] A rewritable thermal label of a non-contact type which comprises a transparent substrate, a rewritable thermal layer disposed on one face of the transparent substrate and an adhesive layer disposed on the rewritable thermal layer and enables to rewrite visible information with laser light in a non-contact manner;
[2] The rewritable thermal label of a non-contact type described in [1], wherein the rewritable thermal layer comprises two layers which are a light absorption and heat conversion layer and a reversible heat sensitive color developing layer disposed on one face of the transparent substrate in this order or a single layer which is a reversible heat sensitive color developing layer comprising an agent for light absorption and heat conversion disposed on one face of the transparent substrate;
[3] The rewritable thermal label of a non-contact type described in any one of [1] and [2], wherein the adhesive layer has white color;
[4] The rewritable thermal label of a non-contact type described in any one of [1] to [3], wherein an anchor coat layer is disposed on a face of the adhesive layer at a side of the transparent substrate;
[5] The rewritable thermal label of a non-contact type described in any one of [1] to [4], wherein the transparent substrate has a transmittance of ultraviolet light of 10% or smaller;
[6] The rewritable thermal label of a non-contact type described in any one of [1] to [5], wherein a coating layer for printing is disposed on one or both faces of the transparent substrate;
[7] The rewritable thermal label of a non-contact type described in any one of [1] to [6], wherein a material of the transparent substrate is a polyester-based resin;
[8] The rewritable thermal label of a non-contact type described in any one of [1] to [7], wherein recording and erasing are conducted with laser light having a wavelength in a range of 700 to 1,500 nm; and
[9] A rewritable thermal label of a non-contact type comprising an IC tag of a non-contact type, which comprises an IC tag enabling to read and write invisible information in a non-contact manner and laminated to a face of the adhesive layer of the rewritable thermal label described in any one of [1] to [8] in a manner such that the IC tag faces the adhesive layer.

### EFFECT OF THE INVENTION

In accordance with the present invention, the rewritable thermal label of the non-contact type which exhibits improved durability in rewriting (resistance to destruction with heat) and improved property for printing while the property for repeated recording and erasing with laser light is maintained and enables to write and/or erase visible information with laser light in the non-contact manner automatically without human labor can be provided.

### BRIEF DESCRIPTION OF THE DRAWING

FIG. 1 shows a diagram exhibiting an image of an example of the rewritable thermal label of the non-contact type of the present invention.

In the Figure, reference numerals mean as follows:

1: A transparent substrate

2: A light absorption and heat conversion layer

3: A heat sensitive color developing layer

4: An adhesive layer

5: A coating layer for printing

6: A print layer

7: A release sheet

8: An adherend

10: A rewritable thermal label

11: A rewritable thermal layer

### THE MOST PREFERRED EMBODIMENT TO CARRY OUT THE INVENTION

The rewritable thermal label of the non-contact type (hereinafter, occasionally, referred to simply as the rewritable thermal label) of the present invention is a label which comprises a transparent substrate, a rewritable thermal layer disposed on one face of the transparent substrate and an adhesive layer for adhesion to an adherend disposed on the rewritable thermal layer and enables to rewrite visible information with laser light in the non-contact manner.

The conventional rewritable thermal label of the non-contact type has a structure such that a rewritable thermal layer is disposed on one face of a substrate and an adhesive layer is disposed on the other face of the substrate. The rewritable thermal label is attached to an adherend via the adhesive layer, and recording and erasing of information are conducted repeatedly by irradiation of the reversible heat sensitive color developing layer with laser light.

In this case, since the energy of laser light is directly provided to the reversible heat sensitive color developing layer, the surface of the rewritable thermal label tends to be destroyed with heat when recording and erasing of information are conducted a plurality of times repeatedly.

The present invention is made to overcome the above problem. In the construction of the present invention, the energy of laser light is provided to the reversible heat sensitive color developing layer not directly but via the transparent substrate. The problem of the destruction of the surface in the conventional rewritable thermal label with heat can be overcome by using the construction of the present invention for the rewritable thermal label.

The transparent substrate used in the rewritable thermal label of the present invention is not particularly limited as long as the transparent substrate satisfies the specific optical requirement, which is, for example, a transmittance of preferably 80% or greater for the used laser light and a transmittance of visible light of preferably 80% or greater, and any desired film material can be used. It is preferable that destruction with heat due to the used laser light is small. Examples of the film material include polyester-based resins and vinyl chloride-based resins. Polyester-based resins are preferable.

Examples of the polyester-based resin include polyethylene terephthalate-based resins, polyethylene naphthalate-based resins, polybutylene terephthalate -based resins and polybutylene naphthalate-based resins.

Examples of the vinyl chloride-based resin include polyvinyl chloride, copolymers containing vinyl chloride as the main component (such as ethylene-vinyl chloride copolymers, vinyl acetate-vinyl chloride copolymers and vinyl chloride-halogenated olefin copolymers) and blends of polyvinyl chloride or a vinyl chloride copolymer as the main component with other compatible resins (such as polyester resins, epoxy resins, acrylic resins, vinyl acetate resins, urethane resins, acrylonitrile-styrene-butadiene copolymers and partially saponified polyvinyl alcohol).

As the vinyl chloride-based resin, in general, a blend comprising about 0 to 70 parts by mass of a plasticizer per 100 parts by mass of the vinyl chloride-based resin is used.

The transparent substrate may comprise various additives such as heat stabilizers, antioxidants, antiweather agents, ultraviolet light absorbents, mold release agents, lubricants, antistatic agents, fillers and antifouling agents as long as the object of the present invention is not adversely affected.

The thickness of the transparent substrate is not particularly limited. From the standpoint of maintaining the transmittance of the laser light and the properties as the label, it is preferable that the thickness is about 10 to 300 μm and more preferably about 20 to 200 μm.

When the transparent substrate has the property of absorbing ultraviolet light, deterioration in the density of images and decomposition of the coloring agent as the dye precursor and the agent for light absorption and heat conversion by the ultraviolet light such as the sun light can be suppressed when the rewritable thermal label used for the recording is left standing after the recording is conducted, and light resistance of the rewritable thermal label can be remarkably improved. Therefore, it is preferable that the transparent substrate has a transmittance of ultraviolet light of 10% or smaller.

When a plastic film is used as the transparent substrate, where desired, the plastic film may be treated on one or both faces by a surface treatment such as the oxidation treatment or the roughening treatment to improve adhesion with various layers formed on the surface. Examples of the oxidation treatment include the treatment by corona discharge, the treatment with chromic acid (a wet method), the treatment with flame, the treatment with the heated air and the treatment with ozone under irradiation with ultraviolet light. Examples of the roughening treatment include the sand blasting and the treatment with a solvent. The surface treatment is suitably selected in accordance with the type of the transparent substrate. In general, the treatment by corona discharge is preferable from the standpoint of the effect and the operability.

In the transparent substrate, a coating layer for printing (ink-receiving layer) may be formed on one or both faces so that the property suitable for printing and durability of printed images can be provided. The type of the coating material for printing used for forming the coating layer for printing is not particularly limited as long as visible information formed on the rewritable thermal layer is visible through the coating layer for printing, and the composition of the coating material can be decided in accordance with the printing method. It is preferable from the standpoint of adhesion of the ink that the glass transition temperature (Tg) of the coating material is in the range of 20 to 100° C. and more preferably in the range of 30 to 70° C. As the coating material, polyester-based resins, acrylic resins and polyurethane resins are preferable, and polyester-based resins are more preferable due to excellent durability to laser light (resistance to destruction with heat). The coating material may be used singly or in combination of two or more. The coating material comprising the resins described above may be a coating material of the non-solvent type or the solvent type.

The method for forming the coating layer for printing which comprises coating on one or both faces of the transparent substrate with the coating material to form a coating film and drying the formed coating film, is not particularly limited. The coating layer can be formed by applying the coating material in accordance with a conventional method such as the gravure coating method or the method using a Mayer bar, an air knife or a die coater to form a coating layer, followed by drying the formed coating film. The thickness of the coating layer for printing is not particularly limited. In general, the thickness is about 0.01 to 10 μm and preferably 0.05 to 5 μm.

By forming the coating layer for printing, a print layer can be formed with excellent adhesion in accordance with a conventional printing method. As the printing method, the letter press printing method, the gravure printing method, the flexo printing method, the screen printing method, the ink jet printing method or the electronic photographic method can be used. The printing ink is not particularly limited. Inks of the ultraviolet curing type are preferable from the standpoint of the durability of the ink.

In the rewritable thermal label of the present invention, the rewritable thermal layer is formed on one face of the transparent substrate. The rewritable thermal label comprises the following three embodiments: (a) an embodiment in which the light absorption and heat conversion layer and the reversible heat sensitive color developing layer are disposed on the substrate in this order, (b) an embodiment in which the reversible heat sensitive color developing layer and the light absorption and heat conversion layer are disposed on the substrate in this order, and (c) the reversible heat sensitive color developing layer comprising the agent for light absorption and heat conversion is disposed on the substrate. Embodiment (a) and embodiment (c) are preferable.

The reversible heat sensitive color developing layer (hereinafter, occasionally referred to simply as heat sensitive color developing layer) in embodiment (a) and embodiment (b) is, in general, constituted with a colorless or slightly colored dye precursor, a reversible color developing agent and, where necessary, binders, accelerators for erasing of color, inorganic pigments and various other additives.

The dye precursor is not particularly limited, and a suitable compound can be selected as desired from compounds conventionally used as the dye precursor in heat sensitive recording materials. For example, one compound or a combination of compounds selected from triarylmethane-based compounds such as 3,3-bis(4-dimethylamino-phenyl)-6-dimethyl-aminophthalide, 3-(4-dimethylaminophenyl)-3-(1,2-dimethylindol-3-yl)-phthalide and 3-(4-diethylamino-2-ethoxyphenyl)-3-(1-ethyl-2-methyl-indol-3-yl)-4-azaphthalide, xanthene-based compounds such as rhodamine B anilinolactam and 3-(N-ethyl-N-tolyl)amino-6-methyl-7-anilinofluorane, diphenylmethane-based compounds such as 4,4′-bis(dimethylaminophenyl)benzhydryl benzyl ether and N-chloro-phenylleucoauramine, spiro-based compounds such as 3-methyl-spirodinaphthopyran and 3-ethylspirodinaphthopyran and thiazine-based compounds such as benzoyl leucomethylene blue and p-nitrobenzoyl leucomethylene blue, can be used.

The reversible color developing agent is not particularly limited as long as the color developing agent reversibly changes the color tone of the dye precursor by the difference in the rate of cooling after heating. Electron accepting compounds comprising phenol derivatives having a long chain alkyl group are preferable from the standpoint of the density of the developed color, the property for erasing the color and the durability in repeated operations.

The phenol derivative may have atoms such as oxygen atom and sulfur atom and amide bond in the molecule. The length and the number of the alkyl group are selected with consideration on the balance between the property for erasing the color and the property for developing the color. It is preferable that the number of carbon atom in the alkyl group is 8 or greater and more preferably about 8 to 24. Hydrazine compounds, anilide compounds and urea compounds having a long chain alkyl group as the side chain can also be used.

Examples of the phenol derivative having a long chain alkyl group include 4-(N-methyl-N-octadecylsulfonylamino)phenol, N-(4-hydroxy-phenyl)-N′-n-octadecylthiourea, N-(4-hydroxyphenyl)-N′-n-octadecylurea, N-(4-hydroxyphenyl)-N′-n-octadecylthioamide, N-[3-(4-hydroxyphenyl)-propiono]-N′-octadecanohydrazide and 4′-hydroxy-4-octadecylbenzanilide.

When information is recorded utilizing the crystallizing property of the reversible color developing agent, the information can be recorded and erased repeatedly by the rapid cooling after heating for the recording of the information and by the slow cooling after heating for the erasing of the information.

Examples of the binder used where necessary for holding components constituting the heat sensitive color developing layer or maintaining uniformity of dispersion of the components include polymers such as polyacrylic acid, polyacrylic esters, polyacrylamide, polyvinyl acetate, polyurethane, polyesters, polyvinyl chloride, polyethylene, polyvinyl acetal and polyvinyl alcohol and copolymers of monomers constituting the polymers.

Examples of the accelerator for erasing of color which is used where desired include ammonium salts. Examples of the inorganic pigment which is used where desired include talc, kaolin, silica, titanium oxide, zinc oxide, magnesium carbonate and aluminum hydroxide. Examples of the other additive which is used where desired include conventional leveling agents and dispersants.

To form the heat sensitive color developing layer, in the first step, a coating fluid is prepared by dissolving or dispersing the dye precursor described above, the reversible color developing agent described above and various additives used where necessary into a suitable organic solvent. As the organic solvent, for example, an alcohol-based solvent, an ether-based solvent, an ester-based solvent, an aliphatic hydrocarbon-based solvent or an aromatic hydrocarbon-based solvent can be used. Tetrahydrofuran is preferable due to the excellent property for dispersion. The relative amounts of the dye precursor and the reversible color developing agent are not particularly limited. The reversible color developing agent is used, in general, in an amount in the range of 50 to 700 parts by mass and preferably in the range of 100 to 500 parts by mass per 100 parts by mass of the dye precursor.

The heat sensitive color developing layer is formed by coating the substrate with the coating fluid prepared as described above in accordance with a conventional method, followed by drying the formed coating layer. The temperature of the drying treatment is not particularly limited. It is preferable that the drying treatment is conducted at a low temperature so that color development of the dye precursor is prevented. The thickness of the heat sensitive color developing layer formed as described above is, in general, in the range of 1 to 10 μm and preferably in the range of 2 to 7 μm.

The light absorption and heat conversion layer in embodiments (a) and (b) is constituted, in general, with the agent for light absorption and heat conversion, the binder and component which are used where necessary such as inorganic pigments, antistatic agents and various other additives.

The agent for light absorption and heat conversion exhibits the function of absorbing laser light supplied by the irradiation and converting the laser light into heat and can be suitably selected in accordance with the used laser light. As the laser light, it is preferable that laser light having a wavelength of oscillation in the range of 700 to 1,500 nm is selected from the standpoint of the convenience of the apparatus and the property for scanning. For example, semiconductor laser light, YAG laser light and FAYb laser light are preferable.

It is preferable that the agent for light absorption and heat conversion absorbs laser light in the near infrared range and generates heat, and that the absorption of light in the visible range with the agent is small. When the agent for laser light absorption and heat conversion absorbs light in the visible range, visibility and readability of bar codes by the rewritable thermal label of the present invention decrease. As the agent for light absorption and heat conversion satisfying the above requirement, organic dyes and/or organometal-based coloring agents are used. Specifically, for example, at least one agent selected from cyanine-based coloring agents, phthalocyanine-based coloring agents, anthraquinone-based coloring agents, azulene-based coloring agents, squalirium-based coloring agents, metal complex-based coloring agents, triphenylmethane-based coloring agents and indolenine-based coloring agents is used.

As the binder, a binder such as the binders described as the examples of the binder for the heat sensitive color developing layer can be used. It is preferable that the light absorption and heat conversion layer is transparent. Therefore, resins of the crosslinking type are preferable as the binder, and resins curable with an ionizing radiation such as ultraviolet light and electron beams are more preferable.

To form the light absorption and heat conversion layer, in the first step, a coating fluid comprising the agent for light absorption and heat conversion, the binder and various additives which are used where necessary is prepared. In the preparation, where necessary, a suitable organic solvent may be used depending on the type of the binder. The relative amounts of the binder and the agent for light absorption and heat conversion are not particularly limited. The agent for light absorption and heat conversion is used, in general, in an amount of 0.01 to 50 parts by mass and preferably in an amount of 0.03 to 10 parts by mass per 100 parts by mass of the binder. However, the agent for light absorption and heat conversion occasionally absorbs light in the visible range, and there is the possibility that the light absorption and heat conversion layer is colored when the amount of the agent for light absorption and heat conversion is great. When the light absorption and heat conversion layer is colored, not only the appearance of the rewritable thermal label but also visibility of information and readability of bar codes are decreased. Therefore, it is preferable that the amount of the agent for light absorption and heat conversion is held small with consideration on the balance with the sensitivity of color development by heating.

In the second step, the coating fluid prepared as described above is coated in accordance with a conventional means to form a coating layer. The formed coating layer is dried and crosslinked by heating or irradiation with an ionizing radiation, and the light absorption and heat conversion layer is formed. The thickness of the light absorption and heat conversion layer formed as described above is, in general, in the range of 0.05 to 10 μm and preferably in the range of 0.1 to 3 μm.

In embodiment (c), the reversible heat sensitive color developing layer comprising the agent for light absorption and heat conversion is formed on the transparent substrate.

In this case, the amount of the agent for light absorption and heat conversion is not particularly limited. The amount is, in general, 0.1 to 30% by mass, preferably 0.2 to 10% by mass and more preferably 0.5 to 5% by mass based on the amount by mass of the entire reversible heat sensitive color developing layer.

The method for forming the reversible heat sensitive color developing layer comprising the agent for light absorption and heat conversion is not particularly limited. Using a coating fluid prepared by adding the agent for light absorption and heat conversion in a specific amount to the coating fluid for forming the heat sensitive color developing layer described above, the reversible heat sensitive color developing layer comprising the agent for light absorption and heat conversion can be formed in accordance with same procedures as those conducted for forming the heat sensitive color developing layer described above.

The thickness of the reversible heat sensitive color developing layer comprising the agent for light absorption and heat conversion formed as described above is, in general, in the range of 1 to 10 μm and preferably in the range of 2 to 7 μm.

In the rewritable thermal label of the present invention, where necessary, an anchor coat layer may be formed on the reversible heat sensitive color developing layer, the light absorption and heat conversion layer or the reversible heat sensitive color developing layer comprising the agent for light absorption and heat conversion (these layers will be referred to as the functional layer) formed as described above. The anchor coat layer is formed for improving adhesion between the functional layer and the adhesive layer formed on the functional layer and for protecting the functional layer from the effects of components in the adhesive layer.

Preferable examples of the resin constituting the anchor coat layer include acrylic resins, polyurethane-based resins and polyester-based resins.

The above resin may be used singly or in combination of two or more. The thickness of the anchor coat layer is not particularly limited and is, in general, 0.05 to 10 μm and preferably 0.1 to 5 μm.

The heat sensitive color developing layer, the light absorption and heat conversion layer and the anchor coat layer in the rewritable thermal label of the present invention can be formed by applying the coating fluid for the respective layer in accordance with a coating method such as the direct gravure coating method, the gravure reverse coating method, the microgravure coating method, the coating method using a Mayer bar, an air knife, a blade, a die or a roll knife, the reverse coating method and the curtain coating method or a printing method such as the flexo printing method, the letter press printing method and the screen printing method to form a coating layer, followed by drying the formed coating layer and by further heating the dried coating layer, if necessary. It is preferable that the heat sensitive color developing layer is dried at a low temperature so that color development is prevented. When a resin of the ionizing radiation curing type is used, the resin is cured by irradiation with an ionizing radiation.

In the rewritable thermal label of the present invention, it is preferable that the adhesive layer formed on the functional layer described above or on the anchor coat layer formed on the functional layer if necessary comprises a pressure sensitive adhesive from the standpoint of convenience for attaching to an adherend.

As the pressure sensitive adhesive constituting the adhesive layer, an adhesive having a resin composition exhibiting excellent adhesion to an adherend and no adverse effects on recycling when the adherend is recycled in combination with the label is preferable. In particular, pressure sensitive adhesives comprising an acrylic acid ester-based copolymer as the resin component are preferable since the property for recycling is excellent due to the excellent compatibility with ABS resins and polystyrene resins frequently used for the adherend. Pressure sensitive adhesives based on rubber, polyesters and polyurethanes can also be used. Although silicone-based pressure sensitive adhesives exhibiting excellent heat resistance can be used, resins obtained in the recycling step tend to be heterogeneous due to poor compatibility with adherends, and this causes a decrease in the strength and poor appearance, occasionally. The pressure sensitive adhesive may be any of pressure sensitive adhesives of the emulsion type, the solvent type and the non-solvent type. Pressure sensitive adhesives of the crosslinkable type are preferable since water resistance in the cleaning step conducted for repeated use of the adherend is excellent, and durability in holding the label is improved. The thickness of the pressure sensitive adhesive is, in general, in the range of 5 to 100 μm and preferably in the range of 10 to 50 μm.

When the pressure sensitive adhesive of the crosslinkable type is used, a conventional crosslinking agent such as an isocyanate-based crosslinking agent, an epoxy-based crosslinking agent and a chelate-based crosslinking agent can be used as the crosslinking agent.

In the rewritable thermal label of the present invention, a white color adhesive may be used for the adhesive layer to improve visibility of the recorded images and readability of optical bar codes. As the white color adhesive, adhesives prepared by adding titanium oxide or a white pigment to the pressure sensitive adhesive described above are preferable. To maintain the readability of optical bar codes, it is preferable that the white color adhesive layer has a reflectance of visible light of 50% or greater and preferably 70% or. greater.

In the rewritable thermal label of the present invention, a release sheet may be disposed on the adhesive layer, if necessary. As the release sheet, release sheets prepared from a substrate for a release sheet such as a plastic film, examples of which include films of polyethylene terephthalate (PET), foamed PET and polypropylene, polyethylene laminate paper, glassine paper and clay coated paper which is coated with a releasing agent, if necessary, can be used. As the releasing agent, silicone-based releasing agents are preferable. Releasing agents based on fluorine and carbamates having a long chain alkyl group can also be used. The thickness of the coating layer of the releasing agent is, in general, in the range of 0.1 to 5.0 μm and preferably in the range of 0.2 to 3.0 μm. The thickness of the release film is, in general, in the range of about 10 to 150 μm, although the thickness is not particularly limited.

The adhesive layer may be formed by directly coating the adhesive to the face of the functional layer having the anchor coat layer of the transparent substrate in accordance with a conventional method such as the method using a roll knife coater, a reverse coater, a die coater, a gravure coater or a Mayer bar coater to form a coating layer, followed by drying the formed coating layer. As another method, after the adhesive layer is formed on the treated face by releasing agent of the release sheet by coating the adhesive in accordance with the above method to form a coating layer, followed by drying the formed coating layer, the formed adhesive layer may be transferred to the functional layer or the anchor coat layer described above by attaching the adhesive layer to the functional layer or the anchor layer. The method of transfer is preferable since the efficiency of drying the adhesive can be increased without developing the color in the heat sensitive color developing layer.

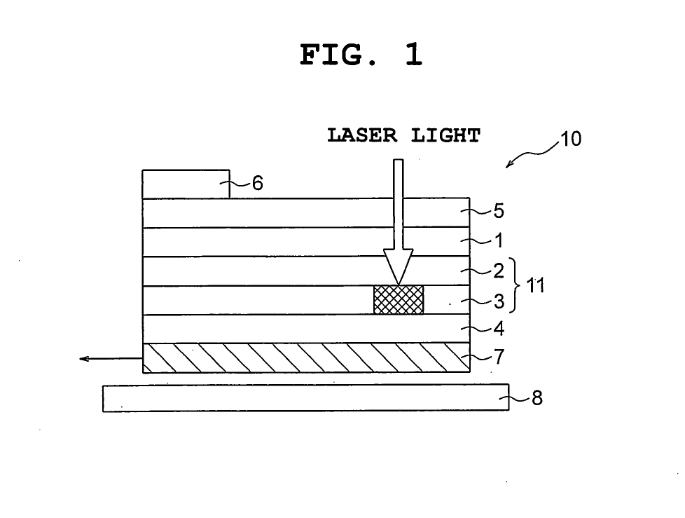

FIG. 1 shows a diagram exhibiting an image of an example of the rewritable thermal label of the non-contact type of the present invention.

In a rewritable thermal label 10, a light absorption and heat conversion layer 2, a heat sensitive color developing layer 3, an adhesive layer 4 and a release sheet 7 are successively disposed on one face of a transparent substrate 1, and a coating layer for printing 5 is disposed on the other face of the transparent substrate 1. In FIG. 1, a print layer 6 is formed on necessary portions on the coating layer for printing 5 disposed on the transparent substrate 1. The coating layer for printing 5 may be formed on the transparent substrate 1 at the side of the light absorption and heat conversion layer 2, and the print layer 6 may be formed on necessary portions on the coating layer for printing 5. In FIG. 1, the numeral 11 means a rewritable thermal layer comprising the light absorption and heat conversion layer 2 and the heat sensitive color developing layer 3.

The rewritable thermal label 10 shown by FIG. 1 can be attached to an adherend 8 to be managed for physical distribution by removing the release sheet 7 attached to the adhesive layer 4, and can then be transported.

In the present invention, it is preferable that near infrared laser beam having a wavelength in the range of 700 to 1,500 nm is used as laser light (laser beam). A wavelength shorter than 700 nm is not preferable since visibility and readability of codes by optical reflection decrease. When the wavelength is longer than 1,500 nm, there is the great possibility that the functional layer is gradually destroyed since the effect of heat is great due to the great energy per unit pulse, and durability in the repeated recording and erasing is decreased.

As the recording mode in a rewritable thermal label of the present invention, a recording mode in which a scanning mirror is continuously driven without activating the oscillation of the laser light and a drawing is conducted by activating the oscillation of the laser light and scanning with the laser light only when the locus of a laser beam which would be assumed to be drawn if the oscillation of the laser light would be activated (the virtual laser beam) moves at a substantially constant speed, is preferable.

It is necessary that the distance between the surface of the rewritable thermal label and the light source of laser be selected with consideration on the density of characters (readability of bar codes) and the size of the characters although the distance is different depending on the scanning speed and the output for the irradiation. The following conditions are preferable for the recording: the output of the laser: about 2.0 to 20 W; the distance for the irradiation: about 150 to 250 mm; and the duty: 70 to 100%. The following conditions are preferable for the erasing: the output of the laser: about 5 to 30 W; the distance for the irradiation: about 200 to 500 mm; and the duty: 70 to 100%. As for the scanning speed, a greater scanning speed is preferable as long as the property for printing or erasing is not adversely affected.

When laser light is used for the irradiation in the minimum amount of energy necessary for the recording for a time as short as possible, a quenching effect is obtained, and an excellent image can be obtained. The quenching effect may also be obtained by blowing a cold air. For the cooling, the scanning with laser light and the quenching with the cold air may be conducted alternately.

The rewritable thermal label in which information has been recorded is attached to an adherend mechanically or manually. When the rewritable thermal label is attached mechanically, the method of pressing by a grid, the roller plunger method in which the label is pressed by a roll or the method of blowing the air can be used. The adherend having the rewritable thermal label is cleaned, where necessary, for the reuse after the object such as the transportation of an article has been achieved. As the method for the cleaning, the method of removing foreign substances by blowing the air, the method of washing with water or the method of cleaning with warm alkaline water can be used.

To reuse the adherend after a use, it is necessary that the information in the attached rewritable thermal label be replaced with a novel information. For this purpose, the image recorded in the label is erased, in the first step.

In the rewritable thermal label of the present invention, the method for erasing is not particularly limited. Examples of the method for erasing include heating with laser light and heating with the heated air. An example of the method for erasing is described in the following.

The erasing is conducted to replace the information in the rewritable thermal label with a novel information. In the first step, the surface of the rewritable thermal label having the previous record is irradiated with near infrared laser light of 700 to 1,500 nm. The rate of residual image can be further reduced by decreasing the rate of cooling in accordance with a method such as the method of bringing into contact with a heating roll and the method of blowing the heated air in combination with the irradiation with laser light having the prescribed amount of energy.

As the heating roll, a conventional heating roll can be used without particular restrictions as long as the heating roll can heat the rewritable thermal label at about 100 to 140° C. and damages are not formed on the surface of the rewritable thermal label. For example, a rubber roll or a stainless steel roll can be used. In particular, a silicone rubber roll exhibiting excellent heat resistance is preferable. It is preferable that the hardness of the rubber is 40 degrees or greater.

The recorded image can also be erased by blowing the heated air. In this case, the heated air of about 80 to 400° C. is applied for about 0.01 to 30 seconds. When deformation of the rewritable thermal label and the adherend with heat and the rate of erasing are considered, it is preferable that the heated air at a high temperature of 100 to 350° C. is applied for a very short time of about 0.01 to 3 seconds.

After the previous information has been erased as described above, the recording of a novel information is conducted in accordance with the method of the non-contact type described above. The adherend and the rewritable thermal label can be used repeatedly by repeating the steps described above.

In the rewritable thermal label of the present invention, the laser energy is applied not directly to the reversible heat sensitive color developing layer but through the transparent substrate, and the durability in rewriting (resistance to destruction with heat) can be improved. Repeated recording and erasing can be conducted 500 times or more. It is possible that the adherend and the rewritable thermal label which have been used the prescribed times are transferred to the recycling step in combination, where necessary.

A system for the management of articles in which information is erased and written in the non-contact manner automatically can be constructed by using the rewritable thermal label of the present invention and attaching the rewritable thermal label to an article to be managed. The present invention also provides a rewritable thermal label of the non-contact type comprising an IC tag of the non-contact type, which comprises an IC tag enabling to read and write invisible information in the non-contact manner and laminated to the face of the adhesive layer of the rewritable thermal label described above in a manner such that the IC tag faces the adhesive layer.

The rewritable thermal label of the non-contact type comprising an IC tag of the non-contact type can be advantageously used for construction of a system for the management of articles since erasing and writing can be conducted using both of a means for recording and erasing invisible information in the IC tag and a means for recording and erasing visible information in the rewritable thermal label.

### EXAMPLES

The present invention will be described more specifically with reference to examples in the following. However, the present invention is not limited to the examples.

The properties of the rewritable thermal labels obtained in Examples and Comparative Examples were evaluated in accordance with the following methods.

### <Method of Recording (Printing)>

Recording was conducted using a FAYb laser (the wavelength: 1,064 nm) [manufactured by SUNX Limited; the trade name: “LP-V10”] as the laser marker used for irradiation with laser.

Ten characters in the alphabet, A to J were recorded under the following conditions: the distance of irradiation: 180 mm; the output of the laser: 10 W; the duty: 100%; the scanning speed: 1,000 mm/second; the pulse period: 100 μs; the width of a line: 0.1 mm; and the distance between lines in forming a solid line: 0.05 mm.

### <Method of Erasing>

The erasing was conducted by blowing the heated air having a temperature of 300° C. at the tip of a nozzle to a recording medium at a distance of 10 mm for 2 seconds, followed by cooling by leaving standing.

### <Test of Rewriting>

Recording and erasing in accordance with the methods described above were repeated 100 times or 500 times.

### (1) Evaluation of a Recorded Image

Using a sample for the test obtained in each Example and Comparative Example, the condition of destruction of the surface and the readability of bar codes were evaluated after the rewriting was repeated the prescribed number of times.

(a) The Condition of Destruction of the Surface

Using a surface roughness meter [manufactured by Mitutoyo Corporation; the trade name: “SV300S4”], the 10-point average surface roughness Rz of a sample was measured before the test of rewriting and after the test of rewriting. The difference between the values of Rz before and after the test of rewriting was obtained and evaluated in accordance with the following criterion:

good: change in Rz: smaller than 1.0 μm

fair: change in Rz: 1.0 μm or greater and smaller than 2.0 μm

poor: change in Rz: 2.0 μm or greater

### When no prints were made (the reference), the value of Rz was 2.11 μm.

(b) Readability of Bar Codes

The readability of bar codes of a sample after the test of rewriting was evaluated using an inspector for bar code reading [manufactured by IZUMI DATA LOGIC Co., Ltd.; “RJS INSPECTOR 3000”]. The result was evaluated in accordance with the ANSI standard.

good: A-D in accordance with the ANSI standard

fair: E or F in accordance with the ANSI standard

poor: reading not possible

### (2) Light Resistance

The test of light resistance was conducted by leaving a sample used for the printing just once in each of Examples and Comparative Examples standing at the outdoor for exposure for 3 days. The readability of bar codes after the exposure was conducted and evaluated in accordance with the same criterion as that described in (b) Readability of bar codes.

good: A-D in accordance with the ANSI standard

fair: E or F in accordance with the ANSI standard

poor: reading not possible

### Preparation Example 1

### Preparation of a Coating Fluid for Forming a Heat Sensitive Color Developing Layer (Fluid A)

Ten parts by mass of 3-(4-diethylamino-2-ethoxyphenyl)-3-(1-ethyl-2-methylindol-3-yl)-4-azaphthalide, which was a triarylmethane-based compound, as the dye precursor, 30 parts by mass of 4-(N-methyl-N-octadecylsulfonylamino)phenol as the reversible color developing agent, 1.5 parts by mass of polyvinyl acetal as the dispersant and 2,500 parts by mass of tetrahydrofuran as the diluting solvent were pulverized and dispersed by a pulverizer and a disper, and a coating fluid for forming a heat sensitive color developing layer (Fluid A) was prepared.

### Preparation Example 2

### Preparation of a Coating Fluid for Forming a Light Absorption and Heat Conversion Layer (Fluid B)

One part by mass of an agent for near infrared light absorption and heat conversion (a nickel complex-based coloring agent) [manufactured by TOSCO Co., Ltd.; the trade name: “SDA-5131”], 100 parts by mass of a binder of the ultraviolet light curing type (a urethane acrylate) [manufactured by DAINICHI SEIKA Color & Chemicals Mfg. Co., Ltd.; the trade name: “PU-5(NS)”] and 3 parts by mass of an inorganic pigment (silica) [manufactured by NIPPON AEROSIL Co., Ltd.; the trade name: “AEROSIL R-972”] were dispersed by a disper, and a coating fluid for forming a light absorption and heat conversion layer (Fluid B) was prepared.

### Preparation Example 3

### Preparation of an Adhesive Layer having a Release Sheet

A polyethylene terephthalate (PET) film having a thickness of 100 μm [manufactured by TORAY INDUSTRIES, INC.; “Lumirror T-60”] was coated with a silicone resin containing a catalyst [manufactured by Dow Corning Toray Co., Ltd.; the trade name: “SRX-211”] to form a coating layer in an amount such that the thickness was 0.7 μm after being dried, and a release sheet was prepared. The silicone resin layer on the prepared release sheet was coated with a coating fluid of a pressure sensitive adhesive prepared by adding 3 parts by mass of a crosslinking agent [manufactured by NIPPON POLYURETHANE INDUSTRY Co., Ltd.; the trade name: “CORONATE L”] to 100 parts by mass of an acrylic pressure sensitive adhesive [manufactured by TOYO INK MFG. Co., Ltd.; the trade name: “ORIBAIN BPS-1109”] to form a coating layer in accordance with the method using a roll-knife coater in an amount such that the thickness was 30 μm after being dried. The obtained film coated with the coating fluid of a pressure sensitive adhesive was dried in an oven at 100° C. for 2 minutes, and an adhesive layer having a release sheet was prepared.

### Example 1

A transparent polyethylene terephthalate film having a thickness of 100 μm and a transmittance of ultraviolet light of 85% [manufactured by TORAY INDUSTRIES, INC.; “Lumirror T-type”] as the substrate was coated with Fluid B prepared in Preparation Example 2 to form a coating layer in accordance with the flexo coating method in an amount such that the thickness was 1.2 μm after being dried. The formed coating film was dried in an oven at 60° C. for 1 minute and then irradiated with ultraviolet light in an amount of 220 mJ/cm², and a light absorption and heat conversion layer was prepared. The light absorption and heat conversion layer prepared above was coated with Fluid A prepared in Preparation Example 1 to form a coating layer in accordance with the gravure coating method in an amount such that the thickness was 4 μm after being dried. The formed coating film was dried in an oven at 60° C. for 5 minutes, and a heat sensitive color developing layer was formed. A rewritable thermal layer having two layers was formed as described above.

The adhesive layer having a release sheet prepared in Preparation Example 3 was laminated with the substrate described above at the face having the heat sensitive color developing layer and the light absorption and heat conversion layer using a laminator, and a rewritable thermal label was prepared.

Using the above substrate, the transmittances of laser light having a wavelength of 1,064 nm and visible light having a wavelength of 550 nm were measured using a spectrophotometer [manufactured by SHIMADZU CORPORATION; the trade name: “UV-3100PC”] and found to be 90% and 90%, respectively.

The properties of the rewritable thermal label were evaluated. The results are shown in Table 1.

### Example 2

The same substrate as that used in Example 1 was coated with a mixed fluid prepared by mixing Fluid A and Fluid B prepared in Preparation Examples 1 and 2, respectively, in amounts such that the ratio of the amounts by mass was 25:1 to form a coating layer in accordance with the flex printing method so that a layer having a thickness of 5.0 μm was formed after being dried. The formed coating film was dried in an oven at 60° C. for 5 minutes and irradiated with ultraviolet light in an amount of 220 mJ/cm², and a rewritable thermal label having a single layer of the heat sensitive color developing layer containing the agent for light absorption and heat conversion was prepared.

The adhesive layer having a release sheet prepared in Preparation Example 3 was laminated with the substrate described above at the face having the heat sensitive color developing layer using a laminator, and a rewritable thermal label was prepared. The properties of the rewritable thermal label were evaluated. The results are shown in Table 1.

### Example 3

A rewritable thermal label having a white color adhesive layer was prepared in accordance with the same procedures as those conducted in Example 1 except that an adhesive layer having a release sheet obtained in accordance with the following method was used as the adhesive layer having a release sheet. The properties of the rewritable thermal label were evaluated. The results are shown in Table 1. The face of the white color adhesive layer had a reflectance of visible light of 75%.

### <Preparation of an Adhesive Layer having a Release Sheet>

Into 100 parts by mass of the acrylic adhesive described in Preparation Example 3, 3 parts by mass of a crosslinking agent “CORONATE L” (described above) and 5 parts by mass of a white pigment [manufactured by VIGteQnos Corporation; the trade name: “LIQUIDINE OP COLOR WHITE 5112”] were dissolved or dispersed to prepare a coating fluid of a pressure sensitive adhesive, and an adhesive layer having a release sheet was prepared in accordance with the same procedures as those conducted in Preparation Example 3.

### Example 4

A rewritable thermal label was prepared in accordance with the same procedures as those conducted in Example 3 except that an anchor coat layer having a thickness of 3 μm was formed on the heat sensitive color developing layer using a coating fluid of a polyurethane acrylate-based resin [manufactured by ARAKAWA KOGYO Co., Ltd.; the trade name: “BEAMSET 500”], and the adhesive layer having a release sheet was laminated with the formed anchor coat layer. The properties of the rewritable thermal label were evaluated. The results are shown in Table 1.

### Example 5

A rewritable thermal label was prepared in accordance with the same procedures as those conducted in Example 3 except that the face of the substrate opposite to the face having the rewritable thermal layer was coated with a polyester resin [manufactured by TOYOBO Co., Ltd.; the trade name: “VYRON 20SS”] in an amount such that the thickness was 0.1 μm after being dried, and the formed coating layer was dried to form a coating layer for printing. The properties of the rewritable thermal label were evaluated. The results are shown in Table 1.

Prints were made on the coating layer for printing using an ink of the UV curing type [manufactured by T&K TOKA Co., Ltd.; the trade name: “BESTCURE 161 India Ink] by a label printer “LPM 3000” manufactured by LINTEC Corporation, and the property for printing was evaluated in accordance with the following method.

### <Property for Printing>

In accordance with the method of Japanese Industrial Standard K 5600-8-5, a pressure sensitive adhesive tape made of cellophane was attached and peeled off. The degree of removal of the printing ink was numerically evaluated into the following 6 grades: (excellent) 0, 1, 2, 3, 4, 5 (poor).

It was found that the property for printing of the rewritable thermal label of the present Example was grade 0.

When the same evaluation was conducted using the rewritable thermal label obtained in Example 3 (no coating layer for printing), the property for printing was found to be grade 5.

### Example 6

A rewritable thermal label was prepared in accordance with the same procedures as those conducted in Example 3 except that a transparent polyethylene terephthalate film having a thickness of 100 μm and absorbing ultraviolet light (the transmittance of ultraviolet light: 5%) [manufactured by TOCHISEN Co., Ltd.; the trade name: “PET 100 UV TOCHISEN”] was used as the substrate in place of the substrate used in Example 3. The properties of the rewritable thermal label were evaluated. The results are shown in Table 1.

Using the above substrate, the transmittances of laser light having a wavelength of 1,064 nm and visible light having a wavelength of 550 nm were measured in accordance with the same procedure as in Example 1 and found to be 90% and 90%, respectively.

### Example 7

After the release sheet was removed, the rewritable thermal label obtained in Example 6 was attached via an adhesive layer to the front face (the upper face) of an IC tag of the non-contact type [manufactured by LINTEC Corporation; the trade name: “TS-L102CC”] constituted with an IC Chip as the means for recording and erasing invisible information and an antenna circuit connected to the IC Chip. The obtained combination was cut into a prescribed shape, and a rewritable thermal label of the non-contact type having an IC tag of the non-contact type was prepared.

### Comparative Example 1

A white color polyethylene terephthalate film having a thickness of 100 μm [manufactured by TORAY INDUSTRIES, INC.; the trade name “Lumirror] as the substrate was coated with Fluid A prepared in Preparation Example 1 to form a coating layer in accordance with the gravure coating method in an amount such that the thickness was 4 μm after being dried. The formed coating film was dried in an oven at 60° C. for 5 minutes, and a heat sensitive color developing layer was formed. The formed heat sensitive color developing layer was coated with Fluid B prepared in Preparation Example 2 to form a coating layer in accordance with the flexo coating method in an amount such that the thickness was 1.2 μm after being dried. The formed coating film was dried in an oven at 60° C. for 1 minute and then irradiated with ultraviolet light in an amount of 220 mJ/cm², and a light absorption and heat conversion layer was prepared. Then, the adhesive layer having a release sheet prepared in Preparation Example 3 was laminated on the face opposite the face of the substrate described above on which the heat sensitive color developing layer and the light absorption and heat conversion layer are formed using a laminator, and a rewritable thermal label was prepared.

The properties of the rewritable thermal label were evaluated. The results are shown in Table 1.

TABLE 1

| | Condition of | | Readability | | |
|---|---|---|---|---|---|
| | destruction of | | of bar codes | | |
| | surface after | | after | | |
| | rewriting | | rewriting | | |
| | 100 times | 500 times | 100 times | 500 times | Light |
| | rewriting | rewriting | rewriting | rewriting | resistance |
| Example 1 | good | good | fair | fair | fair |
| Example 2 | good | good | fair | fair | fair |
| Example 3 | good | good | good | good | fair |
| Example 4 | good | good | good | good | fair |
| Example 5 | good | good | good | good | fair |
| Example 6 | good | good | good | good | good |
| Comparative | fair | poor | fair | poor | fair |
| Example 1 | | | | | |

### INDUSTRIAL APPLICABILITY

The rewritable thermal label of the present invention exhibits improved durability in rewriting (resistance to destruction with heat) and improved property for printing while the property for repeated recording and erasing with laser light is maintained, and a system for the control of distribution of articles which enables to write or erase information automatically in the non-contact manner can be constructed by attaching the label to articles for the control.

What is claimed is:

1. A rewritable thermal label of a non-contact type which comprises a transparent substrate, a rewritable thermal layer disposed on one face of the transparent substrate and an adhesive layer disposed on the rewritable thermal layer and enables to rewrite visible information with laser light in a non-contact manner.

2. The rewritable thermal label of a non-contact type according to claim 1, wherein the rewritable thermal layer comprises two layers which are a light absorption and heat conversion layer and a reversible heat sensitive color developing layer disposed on one face of the transparent substrate in this order or a single layer which is a reversible heat sensitive color developing layer comprising an agent for light absorption and heat conversion disposed on one face of the transparent substrate.

3. The rewritable thermal label of a non-contact type according to claim 1, wherein the adhesive layer has white color.

4. The rewritable thermal label of a non-contact type according to claim 1, wherein an anchor coat layer is disposed on a face of the adhesive layer at a side of the transparent substrate.

5. The rewritable thermal label of a non-contact type according to claim 1, wherein the transparent substrate has a transmittance of ultraviolet light of 10% or smaller.

6. The rewritable thermal label of a non-contact type according to claim 1, wherein a coating layer for printing is disposed on one or both faces of the transparent substrate.

7. The rewritable thermal label of a non-contact type according to claim 1, wherein a material of the transparent substrate is a polyester-based resin.

8. The rewritable thermal label of a non-contact type according to claim 1, wherein recording and erasure are conducted with laser light having a wavelength in a range of 700 to 1,500 nm.

9. A rewritable thermal label of a non-contact type comprising an IC tag of a non-contact type, which comprises an IC tag enabling to read and write invisible information in a non-contact manner and laminated to a face of the adhesive layer of the rewritable thermal label described in claim 1 in a manner such that the IC tag faces the adhesive layer.
